(19) United States
(12) Patent Application Publication
(10) Pub. No.: US 2003/0031313 A1
(43) Pub. Date: Feb. 13, 2003

(54) Method and device for detecting interruptions of speech/data channels in isdn connections

(76) Inventors: Steffen Kessler, Burbach (DE); Lothar Kitz, Ulrichstein (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/220,649

(22) PCT Filed: Feb. 9, 2001
(86) PCT No.: PCT/EP01/01436

(30) Foreign Application Priority Data
Mar. 4, 2000 (DE) 10010784.2

(51) Int. Cl. H04M 1/00; H04M 9/00

(52) U.S. Cl. 379/399.01

(57) ABSTRACT

The invention relates to a method that can be used in telecommunications networks, in particular comprising ISDN connections, to identify, retain and localize an interruption of speech/data channels. Currently, an impaired connection in the signaling channel cannot be differentiated from an unimpaired connection. The input of a tone which is continuously transmitted allows a pause in speech to be differentiated from an interruption of the speech/data channel from a measuring standpoint. It is therefore possible to measure and localize an interruption in an impaired connection. Alternatively, instead of creating a tone, a definable bit pattern can also be input into the B channel.

The present invention relates to a method and a device for detecting and recording interruptions of payload channels in ISDN connections according to the definition of the species in Patent claim 1 and Patent claim 7, respectively.

Methods and devices for checking and detecting or localizing interruptions of data transmission systems, in particular, in ISDN connections, are generally known, as described in the CCITT I-series recommendations, ISDN, “Das diensteintegrierende digitale Fernmeldenetz” [“The Integrated Services Digital Network”] published by Dipl.-Ing. Joachim Claus, December 1993, Publishing House R. v. Decker, G. Schenck, Heidelberg. In ISDN connections, the problem of detecting or localizing an interruption of the payload channels arises time and time again. In the signaling channel, a connection which is disturbed in this manner is usually not distinguishable from a trouble-free connection. This results from the fact that the interlocutors at both ends of the connection terminate the conversation by hanging up because of unidirectional communication or disconnection of the connection.

ITU-T recommendation V.54, pages 309 ff., describes the creation of loop circuits for modems. It also reveals the importance of achieving improvements by reducing interruption times on those connections. The detection of the locations of fault can be accomplished in many cases by loop circuits in the modems. These loops permit local or remote analog or digital checks which can optionally be carried out by the administrative authorities/operating companies and/or by the affected users. Currently, however, there is no possibility of detecting interruptions of payload channels with measuring techniques. There is only the possibility of tracking the communication path, to block parts of the communication path, and to observe whether or not the interruption occurs again. It is difficult to record the payload channel data because firstly a huge amount of data must be recorded and, secondly, the available measuring devices are not capable of recording all payload channel data.

Therefore, it is important to be able to detect and localize the described aborts or unidirectional communications. A further obstacle to the isolation of such an error is the fact that an interruption is not distinguishable from a pause in speech.

Therefore, the object of the present invention is to provide a method for detecting and recording interruptions of payload channels which, in a relatively easy manner, allows a disturbed connection to be distinguished from a trouble-free connection of an ISDN connection and thus to be detected and localized without the need to record a large amount of data and without the need for complicated measuring devices, as well as to devise a circuit arrangement for carrying out the method.

The method according to the present invention is set forth in the characterizing portion of Patent claim 1.

Further design approaches or embodiments of the present invention are set forth in the characterizing portions of Patent claims 2 through 6.

The circuit arrangement for carrying out the method is described in Patent claim 7.

According to the inventive method, a tone is injected into the network, the tone being transmitted continuously or cyclically for filling pauses in speech. In this manner, a speech pause can be distinguished from an interruption of the payload channel with measuring techniques. Therefore, it is possible to measure and localize an interruption in a disturbed existing connection. As an alternative to the generation of a tone, it is also possible to inject a definable bit pattern in the B-channel.

According to the above mentioned method, the inventive circuit arrangement generates a signal which is indeed still recognized and coded by the existing decoder but which is not heard or output at the receiver end. Due to the injected pilot, an analog superposition with the speech signal arises, whereby the data to be transmitted is changed as well. Because of this, the data signal resulting from the tone, the so-called “pilot”, is continuously transmitted in the speech pauses. In the case of malfunction, this pilot can be tracked up to the location where the disturbance occurs or is present.

The exemplary embodiment depicted hereinafter is described on the basis of the injection of an analog tone because an injection, for example, at an So interface would involve additional outlay. However, this does not mean that the inventive method and the circuit arrangement for carrying out the method are limited only to this. As said before, this is only a variant of the solution which makes do without additional outlay at the So interface. Further advantages, features and possible uses of the present invention, follow from the following description in conjunction with the exemplary embodiment shown in the drawing.

In the following, the present invention will be explained in greater detail in the light of exemplary embodiments shown in the drawing. The terms and associated reference symbols specified in the list of reference symbols given at the back are used in the description, in the patent claims, in the abstract, and in the drawing.

In the drawing,

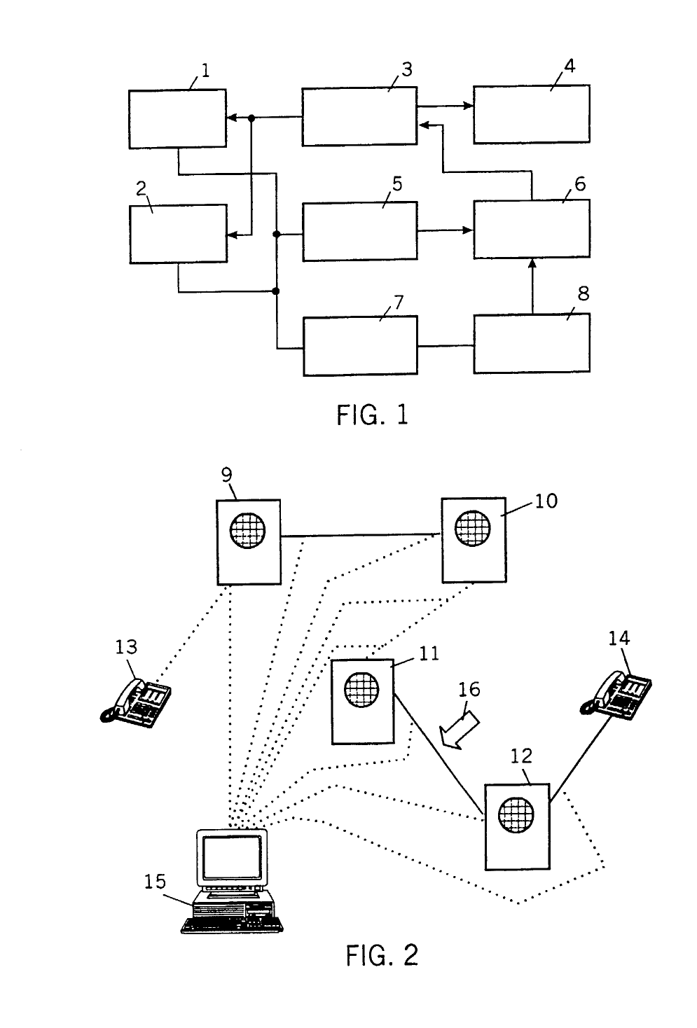

FIG. 1 is a schematic block diagram of a test device; and

FIG. 2 shows a telecommunications network including ISDN network nodes, a measuring device, two terminal devices, and an error source.

Prior to a detailed description of the test device according to FIG. 1, first of all, the fundamentals of the method and also the individual method steps will be described in detail hereinafter.

According to the present method, a tone which is generated by a known generator (not shown here) is injected into the network. This tone is transmitted continuously, allowing a speech pause to be distinguished from an interruption in the payload channel using measuring techniques. Therefore, it is possible to measure, detect and also to localize an interruption in a disturbed existing connection. An alternative to the generation of a tone is, moreover, to inject a defined or definable bit pattern into the B-channel.

In the present exemplary embodiment, the signal generated by the oscillator has a frequency of 100 Hertz and an amplitude of 50 mV. These values were chosen because such a signal can still be coded by coder/decoder 7 of the test device according to FIG. 1 but is not reproduced/output or heard in a disturbing manner at the receiver end. The bit pattern resulting from the injected tone in the payload channel is superposed on the speech data. Because of this, the bit pattern resulting from the tone, which will be referred to as pilot here, is continuously transmitted during speech pauses. In the case of malfunction, the pilot can be tracked up to the location where the disturbance is present so that a clear localization is achieved in this manner.

The following exemplary embodiment will discuss the injection of an analog tone because an injection, for example, at the S₀ interface would involve additional technical outlay. In a variant, the evaluation of the D-channel can be used as a reference for the evaluation of the pilot.

Analog evaluater 5 according to FIG. 1 can be used to check whether the pilot is measurable in the payload channel at the measuring point. The useful signal can be amplified using a preamplifier (not shown). An acceptor circuit, which is not shown either, ensures that the pilot is separated from the useful signals. Using comparator 6 in FIG. 1, it is determined whether or not the pilot was detected in the payload channel. The sensitivity of this comparator 6 is designed to be adjustable. Moreover, the recognition of the pilot is made visible by indicating means 4, for example, an LED indicator.

If the evaluation takes place at digital interfaces, then it is required for the useful signals from the corresponding digital interface 1 or 2 to be converted into analog signals to allow the analog evaluation to be used in the network as well. Analog evaluater 8 is connected downstream of coder/decoder 7 and the output signal is transmitted to comparator 6.

The block diagram of a test device is represented in FIG. 1. It is constituted by a coder/decoder 7 which is connected to interfaces 1 and 2 and which still recognizes and codes the signal which is generated by an oscillator (not shown). The output of coder/decoder 7 is connected to the input of an analog evaluater 8 and to a comparator 6 for the conversation/test signal for the purpose of evaluation. Connected to the other input of comparator 6 is digital evaluater 5 which evaluates the data signals resulting from the injected tone in the payload channel. The output of comparator 6 is connected to a controller 3 which, in turn, is connected to interfaces 1 and 2, which are designed, for example, as S₀ interface and as S_{2M}. Besides, controller 3 is connected to an indicator 4 which indicates the recognition of the pilot, for example, using LED's.

FIG. 2 shows a telecommunications network including four ISDN nodes 9, 10, 11 and 12. Terminal devices 13 and 14 are depicted in the form of telephones at ISDN network nodes 9 and 12, respectively.

Moreover, a measuring device 15 in the form of a PC is provided in a manner that it is connectable to all links between ISDN network nodes 9, 10, 11 and 12. Furthermore, measuring device 15 is equipped such that it is directly connectable to ISDN network nodes 9 and 12 to which are connected terminal devices 13 and 14, respectively. In the present case, it is assumed that the link between ISDN network nodes 11 and 12 is disturbed, i.e., that an error source 16 is present.

Using a terminal device 13 or 14 with injection of a test signal which is referred to as pilot, it is possible for the pilot to be coupled out and recorded at an arbitrary point of the link. In the simplest case, this can technically be implemented using a recording voltmeter. This makes it possible for error source 16 to be localized in the simplest way by reference measurements.

List of Reference Symbols

1 Interface S₀

2 Interface S_{2M}

3 Controller

4 Indicator

5 Digital evaluater

6 Comparator conversation/test signal

7 Coder/decoder

8 Analog evaluater

9-12 ISDN network nodes

13,14 Terminal devices

15 Measuring device

16 Error source

What is claimed is:

1. A method for detecting, recording and localizing interruptions of the payload channels in telecommunications networks, in particular, including ISDN connections,
wherein
initially, a signal is generated which is injected into the network and transmitted continuously or cyclically for filling pauses in speech;
in this manner, it is made possible for a speech pause to be distinguished from an interruption of the payload channel using measuring techniques; and
thus, an interruption in a disturbed existing connection is detectable and localizable with measuring techniques.

2. The method as recited in Patent claim 1,
wherein
in place of the injectable and continuously transmittable tone, a defined or definable bit pattern is injected in the B-channel.

3. The method as recited in Patent claim 1 or 2,
wherein
an oscillator generates a tone or signal having a frequency of 100 Hertz and an amplitude of 50 mV;
the signal is still coded by a coder/decoder (7) and appears at the receiver end in an inaudible or non-disturbing manner;
the injected tone is superposed on the speech; and
the bit pattern resulting from the tone is continuously transmitted during speech pauses as a pilot which, in the case of malfunction, can be tracked up to the location where the disturbance is present, using measuring techniques.

4. The method as recited in one of the Patent claims 1 through 3,
wherein
an analog evaluation is carried out to check the measurability of the pilot in the payload channel, the pilot being separated from the useful signal in a first step;
thereupon, it is determined with a comparator 6 whether or not the pilot was recognized in the payload channel; and
the pilot can be indicated by an indicator (4) upon positive evaluation.

5. The method as recited in Patent claim 4,
wherein
when using the analog evaluation at digital interfaces (1, 2), the useful signals are converted by the corresponding digital interface (1 or 2) into analog signals.

6. The method as recited in one of the Patent claims 1 through 5,
wherein
either an analog tone or a corresponding digital pattern is generated and injected.

7. A circuit arrangement for carrying out the method according to one of the Patent claims 1 through 3.
